(19) United States
(12) Patent Application Publication
(10) Pub. No.: US 2018/0056493 A1
(43) Pub. Date: Mar. 1, 2018

(54) FINGER SHIELD

(71) Applicants: Patricia C. Sands, Arlington, VA (US); Mary M. Riedel, Clifton, VA (US); Sean M. Mauro, Arlington, VA (US)

(72) Inventors: Patricia C. Sands, Arlington, VA (US); Mary M. Riedel, Clifton, VA (US); Sean M. Mauro, Arlington, VA (US)

(21) Appl. No.: 15/688,809

(22) Filed: Aug. 28, 2017

Related U.S. Application Data
(60) Provisional application No. 62/494,954, filed on Aug. 29, 2016.

(51) Int. Cl. B25C 3/00

(52) U.S. Cl. CPC B25C 3/008

(57) ABSTRACT

A finger shield has two arms connected by a U-shaped portion, the arms having respective flanges extending generally transversely to the arms, the flanges being disposed at the top of the respective arms. The U-shaped portion allows flexure so that the arms can be manually squeezed together to hold a nail therebetween. One of the arms has a window for exposing the nail to the fingers of a user, and has a pair of curved indentations disposed on opposite sides of the window, which are aligned to support one side of an inserted nail. The arm having the window also has an indentation or cutout portion at its top portion, to allow insertion of the nail between the two arms such that the nail is guided by the pair of curved indentations. The head of the nail typically extends above the flange.

### CROSS REFERENCE TO RELATED APPLICATIONS

This application claims the priority of Provisional Application No. 62/494,954 filed on Aug. 29, 2016, inventors Patricia C. Sands, Mary M. Riedel, and Sean M. Mauro, entitled “Finger Shield”. The entire disclosure of this provisional patent application is hereby incorporated by reference thereto, in its entirety.

### STATEMENT REGARDING FEDERALLY SPONSORED RESEARCH OR DEVELOPMENT

Not applicable

### FIELD OF THE INVENTION

The present invention relates to device to guard the fingers of a user from hammer strikes, while securely holding a nail steady in place while hammering.

### BACKGROUND OF THE INVENTION

It is a problem in the art to guard the fingers of a user from hammer strikes, while securely holding a nail steady in place while hammering.

In normal use, a nail is held by the fingers of a user, with the point of the nail in contact with a member such as wood. A hammer is then used to strike the head of the nail, thereby causing the nail to become inserted forcibly into the wood. However, it is a problem in that when a hammer strike is slightly off center from the head of the nail, or misses it entirely, the hammer may strike and thereby injure the finders of the user.

### SUMMARY OF THE INVENTION

From the foregoing, it is seen that it is a problem provide a device meeting the above requirements. According to the present invention, a device is provided which meets the aforementioned requirements and needs in the prior art. Specifically, the device according to the present invention provides a device to guard the fingers of a user from hammer strikes, while securely holding a nail steady in place while hammering.

The device of the present invention provides a member having two arms connected by a U-shaped portion, the arms having respective flanges extending generally transversely to the arms, the flanges being disposed at the top of the respective arms. The U-shaped portion is adapted to allow flexure so that the arms can be manually squeezed together to hold a nail therebetween. One of the arms has a window for exposing the nail to the fingers of a user, and has a pair of curved indentations disposed on opposite sides of the window, the curved indentations being aligned to support one side of an inserted nail. The arm having the window also has an indentation or cutout portion at its top portion, which extends into the flange, to allow insertion of the nail between the two arms such that the nail is guided by the pair of curved indentations. The head of the nail extends above the flange in a typical use, and is larger than the cutout portion in the flange. Nails with smaller heads can still be used, if they fit somewhat closely into the indentations.

Other objects and advantages of the present invention will be more readily apparent from the following detailed description when read in conjunction with the accompanying drawings.

### BRIEF DESCRIPTION OF THE DRAWINGS

FIG. 1 is a perspective view of a finger shield according to the present invention, including a phantom outline of a nail being held therein;

FIG. 2 is a perspective view of the finger shield of FIG. 1, omitting the phantom outline of the nail;

FIG. 3 is a bottom perspective view of the finger shield of FIGS. 1 and 2;

FIG. 4 is a top elevational view of the finger shield of FIGS. 1 and 2;

FIG. 5 is a bottom elevational view of the finger shield of FIGS. 1 and 2;

FIG. 6 is a front elevational view of the finger shield of FIGS. 1 and 2.

FIG. 7 is a rear elevational view of the finger shield of FIGS. 1 and 2.

FIG. 8 is a left elevational view of the finger shield of FIGS. 1 and 2.

FIG. 9 is a right elevational view of the finger shield of FIGS. 1 and 2.

### DETAILED DESCRIPTION OF THE INVENTION

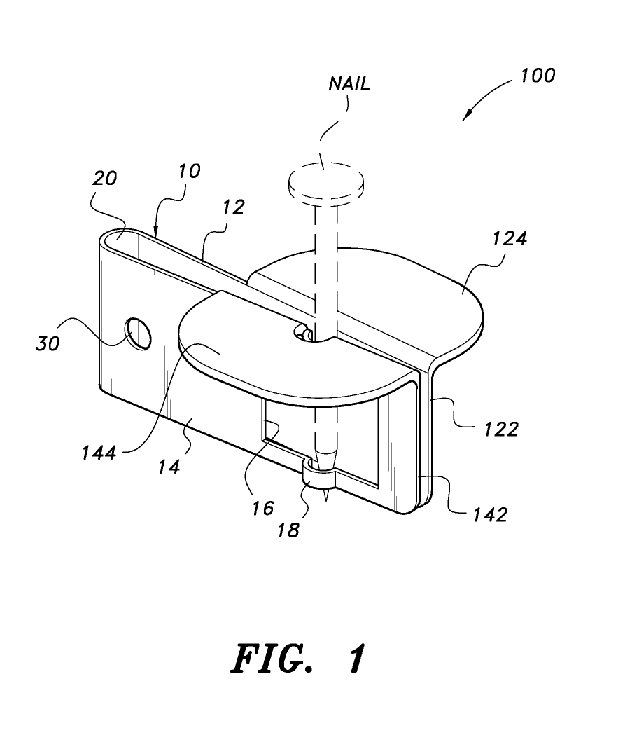

A finger shield 100 is shown in FIG. 1 in a perspective view. The finger shield 100 has a body 10 having a first arm 12, a second arm 14, and a U-shaped portion 20 connecting the first arm 12 and the second arm 14. A flange portion 124 extends outwardly from the first arm 12, and a flange portion 144 extends outwardly from the second arm 14. The flange portions are adapted to protect the fingers of a user during hammering of a nail (shown in phantom outline in FIG. 1).

The U-shaped portion 20 is formed of material that is sufficiently flexible, and is sufficiently think, so that manual pressure on said first arm 12 and said second arm 14 can squeeze them into contact with each other for securing a nail therebetween.

The second arm 14 has a window 16 extending completely through a portion of said second arm 14, to allow passage of the fingers of a user therethrough for grasping a portion of a nail (shown in phantom outline in FIG. 1) held between said first arm 12 and said second arm 14.

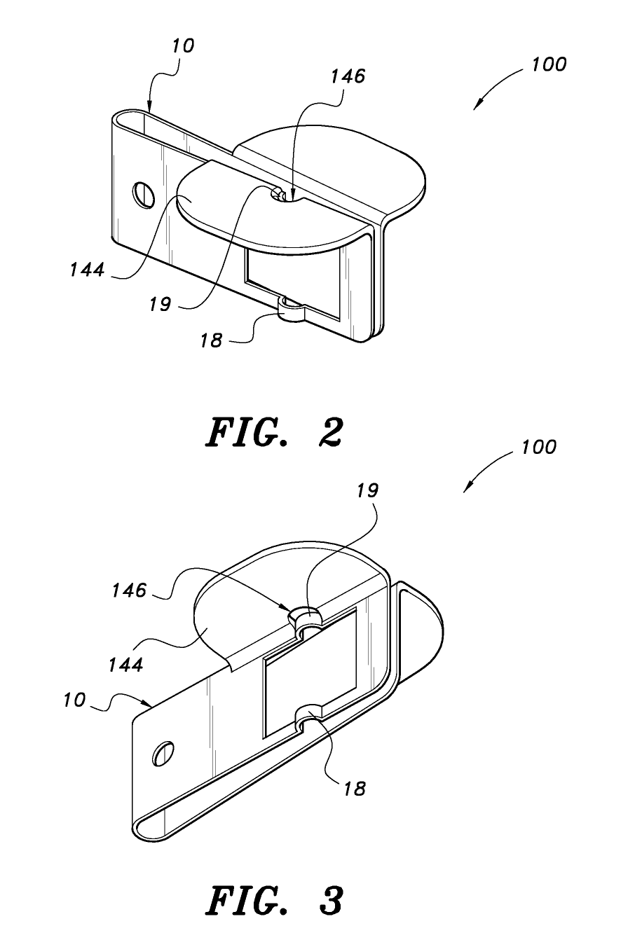

The second arm 14 further includes a first indentation 19 (shown in FIG. 2 and in FIG. 3) in a portion of said second arm 14 above said window 16 for receiving a portion of the nail. The second arm 14 further includes a second indentation 18 in a portion of said second arm 14 below said window 16 for receiving another portion of the nail. The flange portion 144 of the second arm 14 has a recessed portion 146 adjacent the first indentation 19, and has an opening that is enlarged relative to the first indentation 19 and has sloping sides so that it can guide entry of a tip of the nail during insertion of the nail. The first indentation 19 and the second indentation 18 are aligned so that they can receive a nail wherein the nail is inserted tip first into the recessed portion 146 and into the first indentation 19, and the nail continues passing into the second indentation 18. Manual squeezing of the first arm 12 and the second arm 14 together causes gripping of the nail while the flange portions 124 and 144 protect the fingers of a user when hammering said nail.

The indentations 18 and 19 are generally semi-cylindrical in a preferred embodiment. However, they can have other shapes, such as semi-hexagon, semi-rectangular (i.e. having two sides meeting at an angle), non-cylindrical curved shapes such as semi-egg-shaped; and all such variations are contemplated as being within the scope of the present invention.

The window 16 in the second arm 14 is substantially rectangular in the preferred embodiment. However, any other shapes of window can be used, as long as they permit manual contact by the fingers of a user with a portion of the nail being held. All such variations are contemplated as being within the scope of the present invention.

In a preferred embodiment, the finger shield 100, having the first arm 12, the second arm 14, and the U-shaped portion 20 are formed as a continuous planar body having a relatively uniform thickness and a relatively uniform height. Other variations are possible, such as having varied shapes and thicknesses of the first arm 12, the second arm 14, and the U-shaped portion 20. In additional, the U-shaped portion can be replaced by any other type of connecting means including a metal hinge, a hinge with springs, a clip holding the first and second arms 12, 14 together, and any other securing means which would be known to anyone in the mechanical fastener arts.

Additionally, the arms 12, 14 need not be identical to each other, and need not be planar. They need only allow engagement of a portion of the first arm 12 adjacent to the portion of the second arm 14 where the first and second indentations are located, to enable securing a nail by gripping therebetween. The materials can be of any materials such as plastic, metal, and even wood or plant material such as bamboo; any materials can be used which would be known to anyone in the mechanical fastener arts.

Further, in a preferred embodiment, there is an additional opening 30 in the second arm 14 for receiving a portion of a strap (not shown), wherein the additional opening 30 is disposed between the window 16 and the U-shaped portion 20. While a circular opening 30 is shown, the opening can be formed in other shapes, including a rectangular opening. Additionally, a plurality of openings can be provided for securement of a strap, such as a pair of closely-spaced slit-like openings. It is contemplated that other openings can be provided in the arms 12, 14 and in the U-shaped portion 20, without departing from the present invention.

The arms 12 and 14, when held by a user, form a slot along which the nail can be slid during insertion of the nail and also during removal of the nail. In use, the nail is held in the finger shield 100 and a hammer is used to drive the nail partly into the object being nailed (e.g. a wooden board or a picture frame, and so on). Then, pressure is released on the finger shield 100 and it is slid away from the nail, after which hammering can be resumed until the nail is completely inserted into the object being nailed.

The material forming the finger shield 100 can be a metal that is magnetized, so further help secure the nail. Alternatively, the material forming the finger shield 100 can be a non-magnetic material, and have a magnet (not shown) attached to a portion adjacent to the region where the nail is intended to be held (as shown in FIG. 1).

FIG. 2 is a perspective view of the finger shield 100 of FIG. 1, omitting the phantom outline of the nail.

FIG. 3 is a bottom perspective view of the finger shield of FIGS. 1 and 2. It shows the indentation 19, as discussed above, along with the indentation 18.

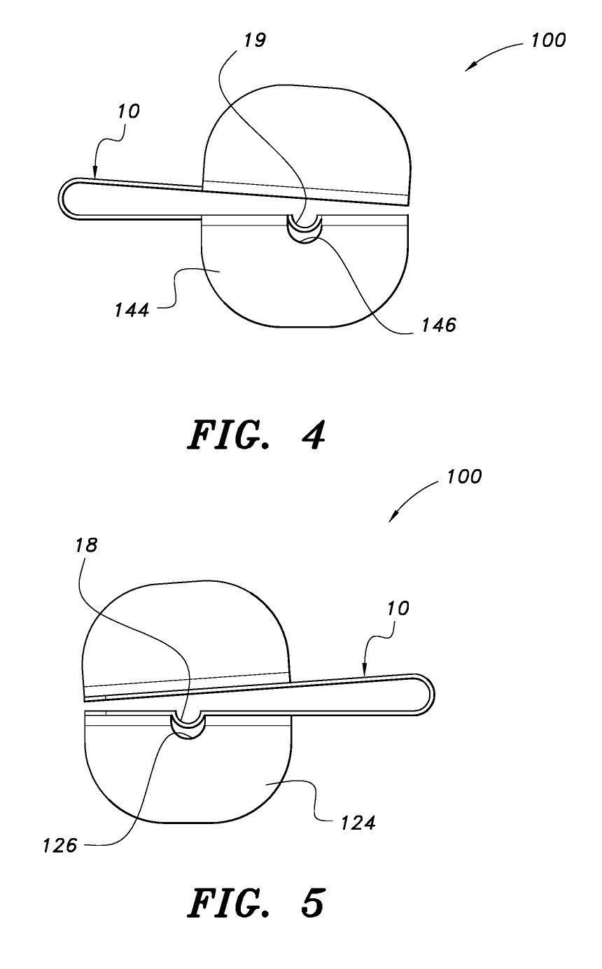

FIG. 4 is a top elevational view of the finger shield 100 of FIGS. 1 and 2. Here, the top side of the top flange 144 shows a sloped opening 146 therethrough which is connected with the indentation 19 on the underside portion of the flange portion 144. The sloped opening 146 is generally funnel-shaped, i.e. generally conical in shape, to facilitate insertion of the tip of a nail therein.

FIG. 5 is a bottom elevational view of the finger shield 100 of FIGS. 1 and 2. Here, the underside of the top flange 146 shows the sloped underside portion 126 of the opening 146.

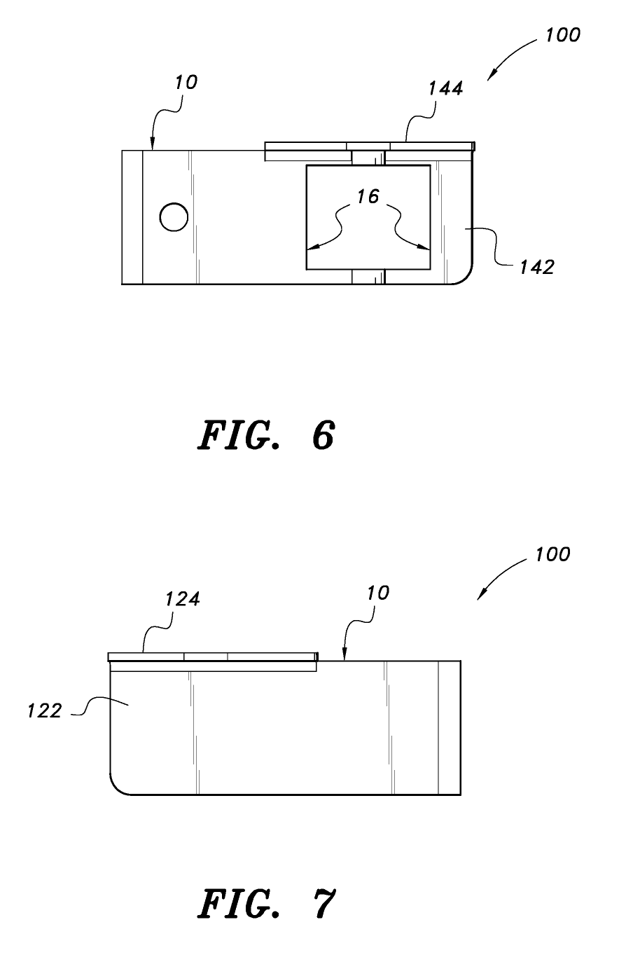

FIG. 6 is a front elevational view of the finger shield 100 of FIGS. 1 and 2.

FIG. 7 is a rear elevational view of the finger shield 100 of FIGS. 1 and 2.

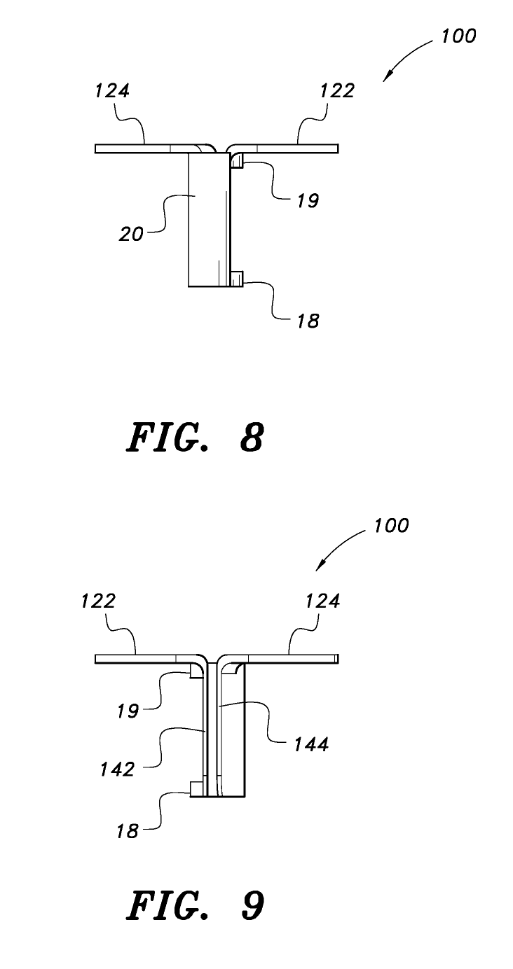

FIG. 8 is a left elevational view of the finger shield 100 of FIGS. 1 and 2.

FIG. 9 is a right elevational view of the finger shield 100 of FIGS. 1 and 2.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A finger shield for protecting the fingers of a user while striking a nail, comprising:
a first arm;
a second arm; and
a U-shaped portion connecting said first arm and said second arm; said U-shaped portion being sufficiently flexible so that manual pressure on said first arm and said second arm can squeeze them into contact with each other for securing a nail therebetween;
said first arm having a flange portion extending outward in a direction away from the second arm, and said second arm having a flange extending outward in a direction away from said first arm;
said second arm having a window extending completely through a portion of said second arm, to allow passage of the fingers of a user therethrough for grasping a portion of a nail held between said first arm and said second arm.

2. A finger shield as claimed in claim 1, wherein said second arm further includes a first indentation in a portion of said second arm above said window for receiving a portion of a nail, and a second indentation in a portion of said second arm below said window for receiving another portion of the nail.

3. A finger shield as claimed in claim 2, wherein said flange portion of said second arm has a recessed portion aligned with the first indentation and said second indentation, such that said recessed portion can receive a nail wherein said nail is inserted tip first into said recessed portion and into said first indentation, and continues passing into said second indentation; whereby manual squeezing of said first arm and said together causes gripping of said nail while said flange portions protect the fingers of a user when hammering said nail.

4. A finger shield as claimed in claim 1, wherein said first arm, said second arm, and said U-shaped portion are formed as a continuous planar body.

5. A finger shield as claimed in claim 4, wherein said first arm, said second arm, and said U-shaped portion have a same height and a same thickness.

6. A finger shield as claimed in claim 1, wherein said window in said second arm is substantially rectangular.

7. A finger shield as claimed in claim 1, further comprising an opening in said second arm for receiving a portion of a strap, wherein said opening is disposed between said window in said second arm and said U-shaped portion.

8. A finger shield as claimed in claim 1, further comprising a strap for connection to said second arm; and an opening in said second arm for receiving a portion of said strap, wherein said opening is disposed between said window in said second arm and said U-shaped portion.
